(19) United States
(12) Patent Application Publication
(10) Pub. No.: US 2008/0127199 A1
(43) Pub. Date: May 29, 2008

(54) Storage sub-system, host computer, storage system, load balancing method and load balancing program

(75) Inventor: Kenichi Miki, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/819,257

(22) Filed: Jun. 26, 2007

(30) Foreign Application Priority Data
Jun. 27, 2006 (JP) 2006-176500

(51) Int. Cl. G06F 9/46

(52) U.S. Cl. 718/105

(57) ABSTRACT

To provide a storage system capable of performing load balancing processing in which a host computer and a storage sub-system cooperate with each other. A controller of the storage sub-system includes functions of generating and updating periodically a load balancing request table, and sending the load balancing request table to the host computer upon request of the host computer. The host computer includes a load balancing performing unit for requesting the storage sub-system to send the load balancing request table, and performing load balancing in accordance with information included in the load balancing request table when a host bus adapter identifying information in the load balancing request table sent by the storage sub-system in response to the request includes information corresponding to a host bus adapter thereof.

### FIELD OF THE INVENTION

This application is based upon and claims the benefit of priority from Japanese patent application No. 2006-176500, filed on Jun. 27, 2006, the disclosure of which is incorporated herein in its entirety by reference.

The present invention relates to a load balancing technique for a storage device, in particular, a technique wherein a storage sub-system and a host computer cooperate with each other to perform a load balancing processing.

### DESCRIPTION OF THE RELATED ART

When a plurality of host computers is connected to a disk array sub-system through a FC (Fibre Channel) switch, a certain host port or a certain controller in the disk array sub-system is loaded intensively, and thereby delay in its response time (host port neck or controller neck) occurs.

It is troublesome to analyze ever-changing I/O performance to conduct load balancing appropriately by human for avoiding this delay in response time.

Japanese Patent Application Laid-open No. 2003-296153 describes that a storage device performing load balancing within a storage sub-system.

This storage system comprises a plurality of storage processing sections in the storage sub-system, and processing loads are measured at each of the storage processing sections. Further, maximum/minimum thresholds are defined with respect to the load.

When an arbitrary storage processing section is loaded more than the maximum value, it inquires of other storage processing sections their load status so as to distribute a load thereof to a low loaded storage processing section. When an arbitrary storage processing section is loaded less than the minimum value, it inquires of other storage processing sections their load status so as to release a load thereof to a low loaded storage processing section, and the arbitrary storage processing section itself goes into a power-saving mode.

As described, the load balancing for the storage processing sections improves responses to the host and power efficiency.

According to the aforementioned related art, the load balancing processing is performed in a storage sub-system (the storage processing section) only, and a host computer and the storage sub-system cannot work along with each other to perform the load balancing processing.

### SUMMARY OF THE INVENTION

Thus, it is an exemplary object of the present invention to provide a storage system and the like in which a host computer and a storage sub-system can cooperate with each other to perform load balancing processing.

As an exemplary aspect of the invention, a controller of a storage sub-system according to the present invention comprises the functions of: generating and updating periodically a load balancing request table including information which indicates whether each host port needs to be load-balanced or not, host bus adapter identifying information which identifies a host bus adapter of the host computer requesting load balancing, and information which identifies a host port to share a load; and sending the load balancing request table to the host computer upon request of the host computer.

As a more exemplary aspect of the invention, the host computer according to the present invention comprises: a load balancing performing unit for requesting a storage sub-system to send a load balancing request table including information which indicates whether each host port in the storage sub-system needs to be load-balanced or not, host bus adapter identifying information which identifies the host bus adapter requesting load balancing, and information which identifies a host port to share a load, and performing load balancing according to the information included in the load balancing request table when the host bus adapter identifying information in the load balancing request table which is sent from the storage sub-system in response to the request includes information corresponding to a host bus adapter thereof.

As another exemplary aspect of the invention, the storage system according to the present invention comprises: a host computer; and a storage sub-system.

The storage sub-system has a plurality of host ports for receiving an I/O command from the host computer, and a controller for performing read-out/write-in from/to a storing device in accordance with the I/O command, wherein the controller has the functions of generating and updating periodically a load balancing request table including information which indicates whether each host port needs to be load-balanced or not, host bus adapter identifying information which identifies a host bus adapter of the host computer requesting load balancing, and information which identifies a host port to share a load, and sending the load balancing request table to the host computer upon request of the host computer.

As still another exemplary aspect of the invention, the host computer has a plurality of host bus adapters which sends an I/O command to the storage sub-system and a load balancing performing unit for requesting the storage sub-system to send the load balancing request table, and performing load balancing in accordance with the information included in the load balancing request table when the host bus adapter identifying information in the load balancing request table which is sent from the storage sub-system in response to the request includes information corresponding to a host bus adapter thereof.

As a further aspect of the invention, a load balancing method according to the present invention is described as follows: a storage sub-system generates and updates periodically a load balancing request table including information which indicates whether each host port needs to be load-balanced or not, host bus adapter identifying information which identifies a host bus adapter of a host computer requesting load balancing, and information which identifies a host port to share a load; a host computer requests the storage sub-system to send the load balancing request table; the storage sub-system sends the load balancing request table to the host computer in response to the request; and the host computer performs load balancing in accordance with the information included in the load balancing request table when the host bus adapter identifying information of the load balancing request table received from the storage sub-system includes information corresponding to a host bus adapter thereof.

As a still further exemplary aspect of the invention, load balancing program according to the present invention makes a storage sub-system execute the processes of: generating and updating periodically a load balancing request table including information which indicates whether each host port needs to be load-balanced or not, host bus adapter identifying information which identifies a host bus adapter of a host computer requesting load balancing, and information which identifies a host port to share a load; and sending the host balancing request table to the host computer upon request of the host computer.

As a still further exemplary aspect of the invention, a second load balancing program according to the present invention makes a host computer execute the processes of: requesting a storage sub-system to send a load balancing request table including information which indicates whether each host port of the storage sub-system needs to be load-balanced or not, host bus adapter identifying information which identifies a host bus adapter requesting load balancing, and information which identifies a host port to share a load; and performing load balancing in accordance with the information included in the load balancing request table when the host bus adapter identifying information in the load balancing request table which is sent from the storage sub-system in response to the request includes information corresponding to a host bus adapter thereof.

According to the present invention, the storage sub-system sends the load balancing request table in response to a request of the host computer. The load balancing request table indicates information such as the one specifying a host port to share a load, so that the host computer can perform load balancing processing in accordance with the information included in the load balancing request table. That is, an autonomous load balancing function can be realized in which the storage sub-system and the host computer cooperate with each other.

### BRIEF DESCRIPTION OF THE DRAWINGS

FIG. 1 is an overall block diagram showing a SAN system which is one exemplary embodiment of the present invention;

FIG. 2 is a functional block diagram of a host computer and a disk array sub-system;

FIG. 3 is a flowchart showing a receiving command processing operation of the disk array sub-system;

FIG. 4A is a flowchart showing a processing operation of a WWPN obtaining command of the disk array sub-system, FIG. 4B is a flowchart showing a processing operation of a load balancing request table obtaining command of the disk array sub-system;

FIG. 5 is a flowchart showing a path monitoring operation of the host computer;

FIG. 6 is a diagram showing an example of the load balancing request table;

FIG. 7 is a diagram showing an example of the load balancing request table; and

FIG. 8 is a diagram showing an example of the load balancing request table.

### DESCRIPTION OF EXEMPLARY EMBODIMENTS

Hereinafter, configurations and operations of a SAN (Storage Area Network) system 50 (one example of a storage system), which is one exemplary embodiment of the present invention, will be explained with reference to the drawings.

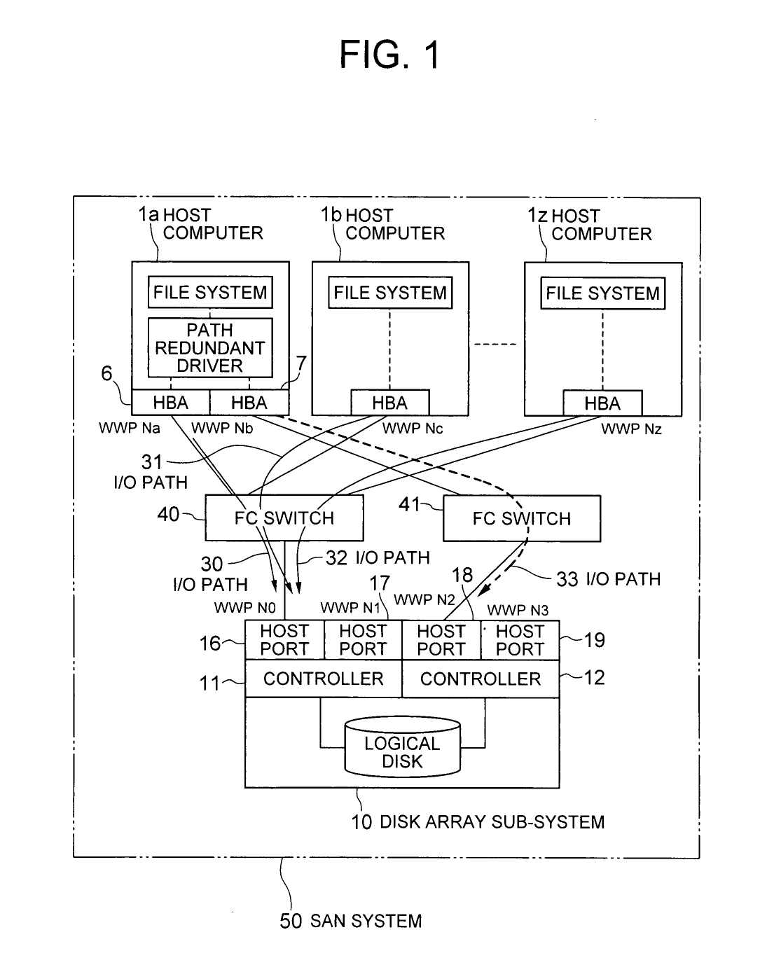

FIG. 1 is an overall block diagram of the SAN system 50. The SAN system 50 comprises a plurality of host computers 1a, 1b, etc. (hereinafter, referred to as “host computer 1” in a case where there is no need to distinguish them) and a disk array sub-system 10 (one example of a storage sub-system).

The host computer 1 has host bus adapters (hereinafter, referred to as “HBAs”), and the disk array sub-system 10 has host ports. The HBAs and the host ports are connected to each other through FC switches 40 and 41. The HBAs and the host ports are given a WWPN (World Wide Port Name), such as “WWPNa” and the like, as shown in parentheses of FIG. 1. The WWPN is a 64-bit address to identify a port uniquely, which is written in a ROM (Read Only Memory) when the HBA and the controller are manufactured.

The host computer 1 issues an I/O command to the disk array sub-system 10 through access paths 30, 31, 32, and performs read-out/write-in data from/to a logical disk.

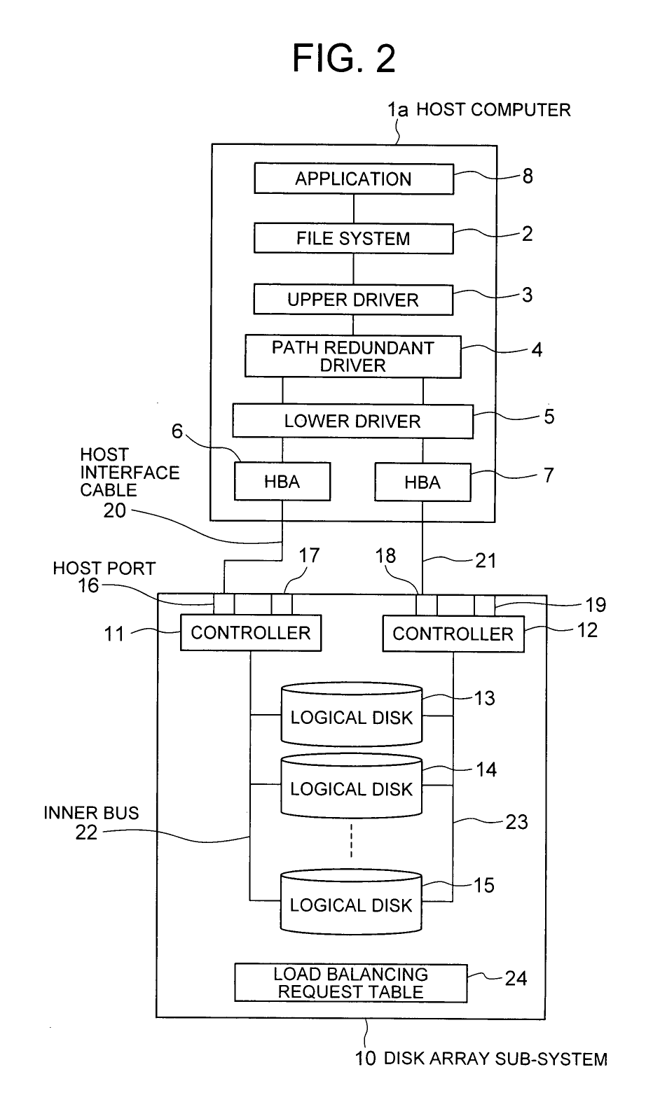

FIG. 2 is a functional block diagram for the host computer 1a and the disk array sub-system 10 in FIG. 1.

The host computer 1a has a file system 2, an upper driver 3, a path redundant driver 4, a lower driver 5, two of HBAs 6 and 7.

The disk array sub-system 10 has two of controllers 11, 12 and logical disks 13, 14, 15, and the like.

(A Configuration of the Host Computer 1a)

An application 8 is an arbitrary application program which is executed by a CPU (Central Processing Unit) of the host computer 1, and requests the file system 2 to read-out/write-in a file from/to the logical disk 13 and the like.

The file system 2 maintains a link between a file name of a file in the logical drive and a storage location in the logical drive.

The upper driver 3 passes an I/O given by the application 8 through the file system 2 to the path redundant driver 4.

The HBAs 6 and 7 are connected to host ports 16 and 18 at controllers 11 and 12 of the disk array sub-system 10 through host interface cables 20 and 21 respectively, and the host computer 1 performs an I/O for logical disks 13, 14 and 15 controlled by the disk array sub-system 10.

The lower driver 5 controls the HBAs 6 and 7 so as to perform an I/O processing.

The path redundant driver 4 passes an I/O received from the upper driver 3 to the lower driver 5, and receives a result of the I/O performance for the logical disks 13, 14 and 15 controlled by the disk array sub-system from the lower driver 5 through the HBA 6 or 7, so as to determine whether normal termination or abnormal termination. The path redundant driver 4 performs a retry processing of the I/O which has ended up the abnormal termination by using a substitute path when it is determined that the abnormal termination is caused by failure (malfunction) of component parts of the path (such as the HBAs 6, 7, the host interface cables 20, 21, and controllers 11, 12).

According to the present invention, the path redundant driver 4 obtains the load balancing request table 24 from the disk array sub-system 10, and performs load balancing in accordance with information included in the table.

Specifically, the path redundant driver 4 comprises a function of performing load balancing of I/Os (distributing the I/Os to the host ports 16, 17, 18, 19 at the controller 11 or 12) utilizing a plurality of I/O paths effectively so that the I/Os do not centralized at one of the I/O paths (for example, the controller 11) only.

That is, the path redundant driver 4 and a CPU executing the above is one example of a load balancing performing unit.

Results of each I/O performance by the host computer 1 are assessed at each layer of the HBA 6, the lower driver 5, the path redundant driver 4, the upper driver 3, the file system 2 and the application 8, and some sort of processing are performed if necessary.

A host computer 1b and the like have the same kind of configuration as the one of the host computer 1a. However, some of those host computers may not include the path redundant driver 4.

### (A Configuration of the Disk Array Sub-System 10)

The controllers 11 and 12 are connected to the logical disks 13, 14 and 15 through internal buses 22 and 23 respectively, and both of the controllers can access each logical disk.

The controllers 11 and 12 generate the load balancing request table 24, store it into the storage device such as a RAM and the like, and update it periodically. Further, the controllers 11 and 12 send the load balancing request table 24 to the host computer in response to a request of the host computer 1.

Details of the load balancing request table 24 will be described later.

Data (write data forwarding I/O) which is written in the disk array sub-system 10 by the application 8 operating in the host computer 1 goes through the application 8, the file system 2, the upper driver 3, the path redundant driver 4, the lower driver 5, the HBA 6, the host interface cable 20, the host port 16 and reaches the controller 11, then is written in the assigned logical disk 13, 14 or 15.

Data (read data forwarding I/O) read out from the disk array sub-system 10 by the application 8 operating in the host computer 1 goes from the assigned logical disk 13, 14 or 15, through to the controller 11, the host port 16, the host interface cable 20 and reaches the HBA 6, and further goes through the lower driver 5, the path redundant driver 4, the upper driver 3, the file system 2, and reaches the application 8.

The logical disk 13 and the like are storage areas recognized as each of independent storage devices by the application program 8. The logical disk 13 may be configured with a part of or the whole of storage area of one physical storage device (for example, a hard disk device), or may be configured with a plurality of physical storage devices.

Next, operations of the SAN system 50 will be explained.

Firstly, operations of the disk array sub-system 10 side will be described.

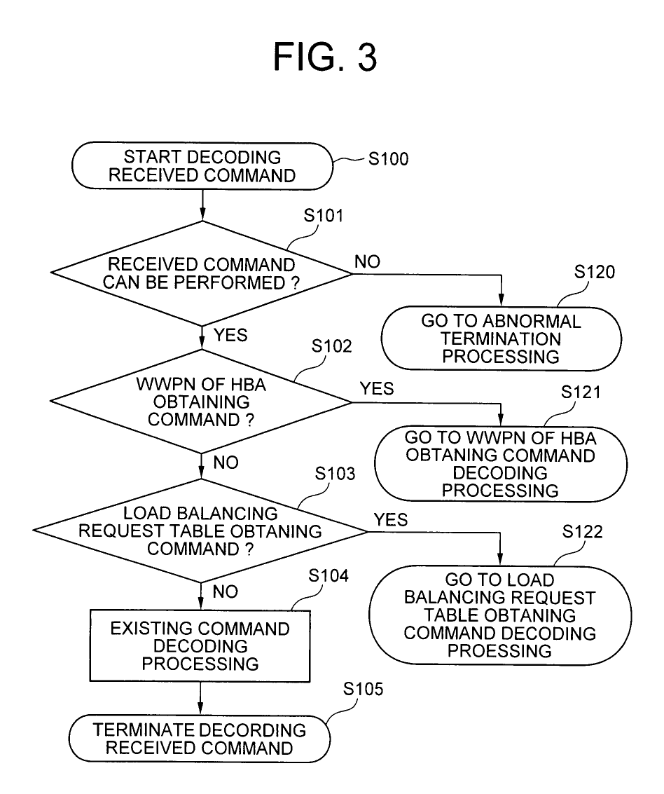

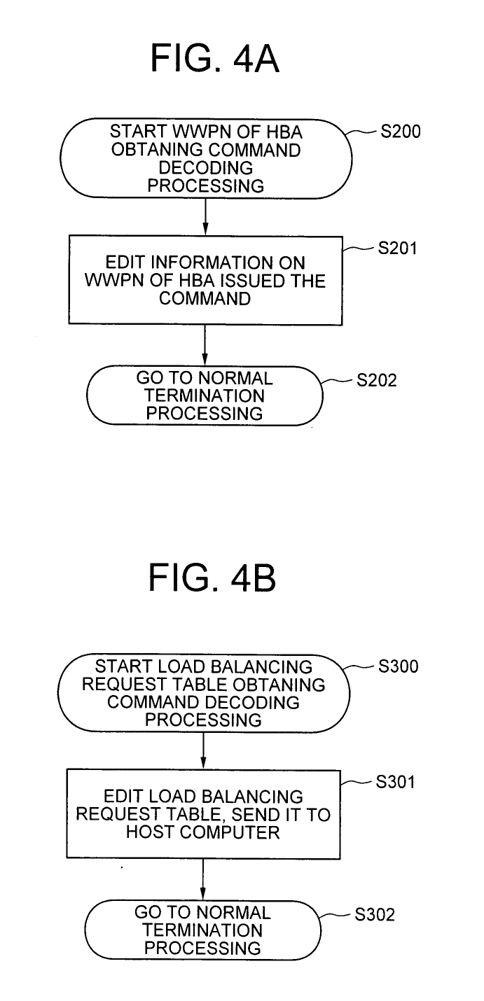

FIGS. 3, 4A and 4B are flowcharts showing a part of processing process of an I/O command received from the host computer 1 conducted by the controllers 11 and 12 of the disk array sub-system 10.

A command received from the host computer 1 is determined by the controllers 11 and 12 whether it can be performed normally or not (S101 of FIG. 3), and if the command is not to be performed normally, the process moves to an abnormal termination processing (S120).

If the command is one capable of being performed normally, the controllers 11 and 12 determine whether it is an obtaining command for a WWPN of a HBA which has issued the command (S102).

If it is the WWPN of HBA obtaining command, the process moves to a WWPN of HBA obtaining command decoding processing (S121), while if it is not, the process moves to S103.

If the process moves from S102 to the WWPN of HBA obtaining command decoding processing (S121), the WWPN of the HBA which has issued the command is edited (S201 of FIG. 4A), and the process moves to a normal termination processing (S202).

A WWPN is edited in a following procedure, for example.

(1) A “WWPN of HBA obtaining command” is defined preliminarily in the system;

(2) The path redundant driver 4 issues the “WWPN of HBA obtaining command” through the every HBAS, once per HBA, so as to recognize (obtain) the WWPN of HBA (which has issued an I/O (an I/O path)) that is to be controlled by the path redundant driver 4 itself;

(3) When the disk array sub-system 10 receives the “WWPN of HBA obtaining command”, edits the WWPN of the issuing HBA (as data to be returned), then returns it as a performance result of the command to the path redundant driver 4; and

(4) The path redundant driver 4 obtains the returned data so as to be able to recognize (obtain) the WWPN of the HBA.

If it is not the WWPN of HBA obtaining command, the controllers 11 and 12 determines whether it is a load balancing request table obtaining command or not (determination at S102 is No, S103). If it is the load balancing request table obtaining command, the process moves to a load balancing request table obtaining command decoding processing (S122), while if it is not, moves to S104.

When the process moves to the load balancing request table obtaining command decoding processing (S122) from S103, the load balancing request table 24 is edited and sent to the host computer 1 which has been requested to obtain it (S301 of FIG. 4B), and the process moves to a normal termination processing (S302).

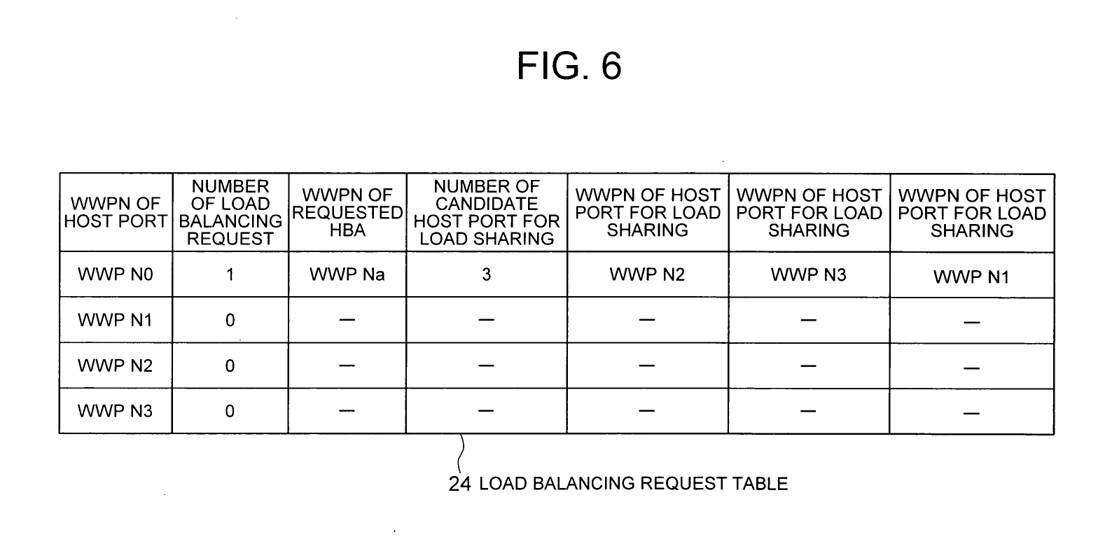

As shown in FIG. 6, the load balancing request table edited here comprises information on WWPNs of host ports at each controller 11 and 12 of the disk array sub-system 10, a number of load balancing requests, WWPNs of a HBA requesting load balancing, a number of candidate host ports which are to share a load, and WWPNs of candidate host ports which are to share a load.

The number of load balancing requests is the number of HBAs requesting load balancing with respect to the I/Os to a host port. When load balancing with respect to the I/Os to the host port is not necessary, the value is to be “0”. Number of the section “WWPN of requesting HBA” is depending on the number of load balancing request. For example, when the “number of load balancing request” is “2”, there are two of the sections for “WWPN of a requesting HBA”, and the values thereof are to be, for example, “WWPNa”, “WWPNb”, and the like.

A HBA requesting load balancing is selected on the basis of following criteria.

(1) A HBA is selected which sends I/Os the most to a host port loaded intensively; and

(2) A HBA requesting load balancing is selected and leaded so as to issue I/Os to a more suitable host port than a current host port, if it exists, to process the I/Os, after a storage location for actual data specified by the issued I/O to a host port determined.

The WWPN of a requesting HBA is a WWPN of a HBA which requests load balancing. The path redundant driver 4 of the host computer 1 refers to the section, and if there is a WWPN of a HBA managed by the path redundant driver 4, the path redundant driver 4 distributes I/Os, which are to be usually sent to a host port shown as 1 or more in the section of number of load balancing request, to one host port or more of which WWPNs is written in the section of the WWPN of host port for load sharing.

Considering a situation in which the host port 16 (WWPN0) in FIG. 1 is loaded intensively, when it is determined that delay in response of the host port 16 can be avoided in a case where the controllers 11 and 12 of the disk array sub-system 10 obtain and analyze I/O statistical information for a certain period in the past so as to distribute I/Os for the HBA 6 (WWPNa) to either of the host port 18, 19 or 17 (WWPN2, WWPN3, WWPN1), “1” as the number of load balancing request, “WWPNa” as the WWPN of requesting HBA, “3” as the number of candidate host ports for load sharing, and “WWPN2”, “WWPN3”, “WWPN1” as WWPNs of candidate host ports for load sharing are edited at appropriate sections for the host port 16 (a first line in FIG. 6).

The disk array sub-system 10 takes every HBAs connected to the disc array sub-system 10 as candidates for a requesting HBA of the load balancing request table expecting that each host computer has the path redundant drivers 4. However, a requesting HBA, which does not respond to a load balancing request within a certain period after the load balancing request table is sent, is cleared from the load balancing request table 24.

Returning to FIG. 3. When the received command is neither the WWPN of HBA obtaining command nor the load balancing request table obtaining command, an existing command decoding processing (existence processing) is performed (determinations at S102 and S103 are No, S104).

Next, operations of the path redundant driver 4 will be explained.

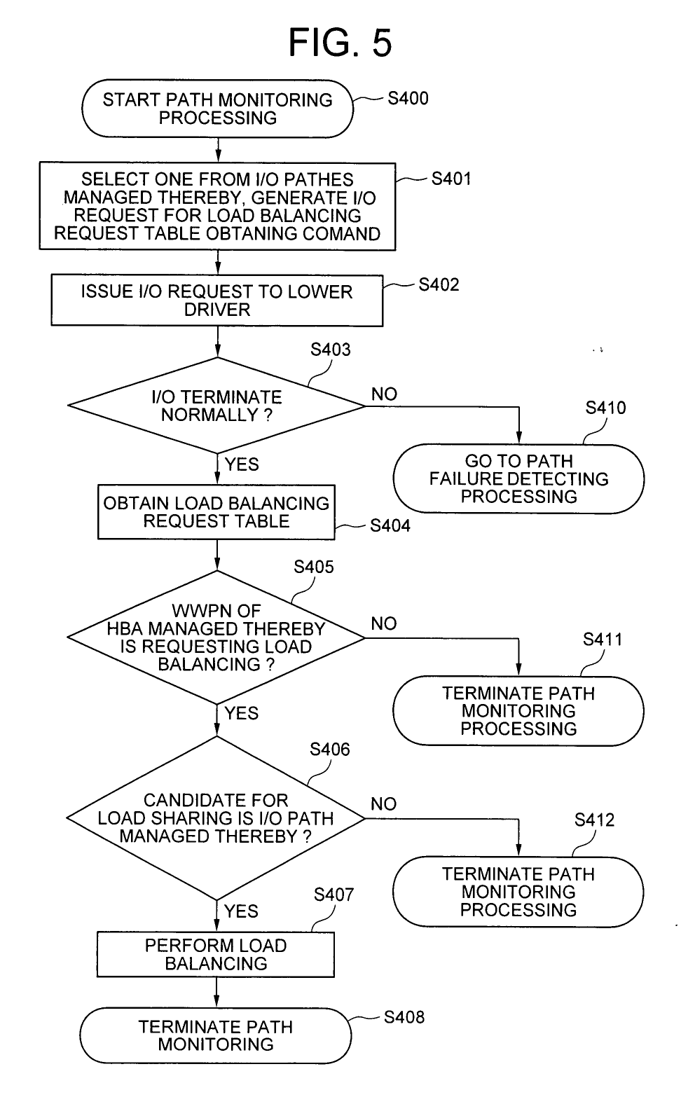

FIG. 5 is a flowchart showing a part of processing performed by the path redundant driver 4 in FIG. 1, in particular, it relates to a path monitoring processing. The path monitoring is a continuity test in which I/Os are generated and issued at each certain period to a plurality of I/O paths managed by the path redundant driver 4 so as to confirm whether a failure occurs or not. The I/O used for the monitoring is generated and issued by the path redundant driver 4 at every certain period asynchronously with the I/O issuance period of the application 8. An object being to confirm continuity, an INQUIRY command and the like have been utilized as the I/O used for the path monitoring.

Here, the description proceeds on the basis that the path redundant driver 4 has obtained a WWPN of a HBA managed by the path redundant driver 4 itself or an I/O path managed by the path redundant driver 4 itself, in an initialization phase thereof, that is, that the path redundant driver 4 has obtained a WWPN of the host port 16 and the like of the disk array sub-system 10.

One of the I/O paths managed by the path redundant driver 4 is selected, and an I/O request with respect to the load balancing request table obtaining command is generated (S401), then the I/O request is issued to the lower driver 5 (S402).

A performance result of S402 is confirmed at S403. If it is an abnormal termination, which means that an I/O path failure occurs, the process moves to an abnormal termination processing (S410).

If it is a normal termination, which means that the load balancing request table has been obtained (S404), the path redundant driver 4 determines that whether a WWPN of a HBA managed by the path redundant driver 4 itself is in the load balancing request table or not (S405), and terminates the path monitoring processing in a case of no WWPN of HBA managed by itself (S411).

If there is a WWPN of a HBA managed by the path redundant driver 4 itself, it determines that whether a candidate host port to share loads is in an I/O path managed by the path redundant driver 4 itself or not (S406), and if it is not in the I/O path managed by it, the path monitoring processing is terminated (S412).

In S407, one or a plurality of I/O paths managed by the path redundant driver 4 is selected from the candidate host ports for load sharing in the load balancing request table, and load balancing is performed.

For example, in a case where a received load balancing request table is the one shown in FIG. 6, the path redundant driver 4 selects “WWPN2” corresponding to the host port 18 among the “WWPN of the host port to share loads” because “WWPNa” corresponding to HBA 6 is included in the “WWPN of the requesting HBA”, and distributes an I/O, which is normally sent through an I/O path 31 in FIG. 1, using an I/O path 33.

As described above, a unit is provided to distribute loads centralized at a certain host port to other host ports.

Next, an effect of the SAN system 50 will be explained.

A first effect is that an autonomous load balancing function can be provided with a whole system by cooperative and collaborative operation between the path redundant driver 4 and the disk array sub-system 10.

A second effect is that an extra I/O load for a path monitoring (continuity confirmation for a path) is not generated.

The reason is that the load balancing request table obtaining command is used in stead of a command used for the path monitoring, that is, the load balancing request table is obtained, and the load balancing request table has been obtained means normal termination of the command and works as the path monitoring, too. Accordingly, an extra I/O load does not generated by the present invention, while the conventional path redundant driver issues commands (such as a “INQUIRY command”, a “TEST UNIT READY command”, and the like) periodically for path monitoring, and determines that there is no failure in the path in a case of normal termination of the command.

A third effect is that the upper driver 3, the lower driver 5, a middleware and the application 8 does not need to be remodeled because cooperation of the path redundant driver 4 and the disk array sub-system, and besides, management and control thereof are performed covered within the path redundant driver 4.

The SAN 50 system shown in FIGS. 1 and 2 is one example of exemplary embodiments in the present invention, and the present invention can be also realized in the following exemplary embodiment.

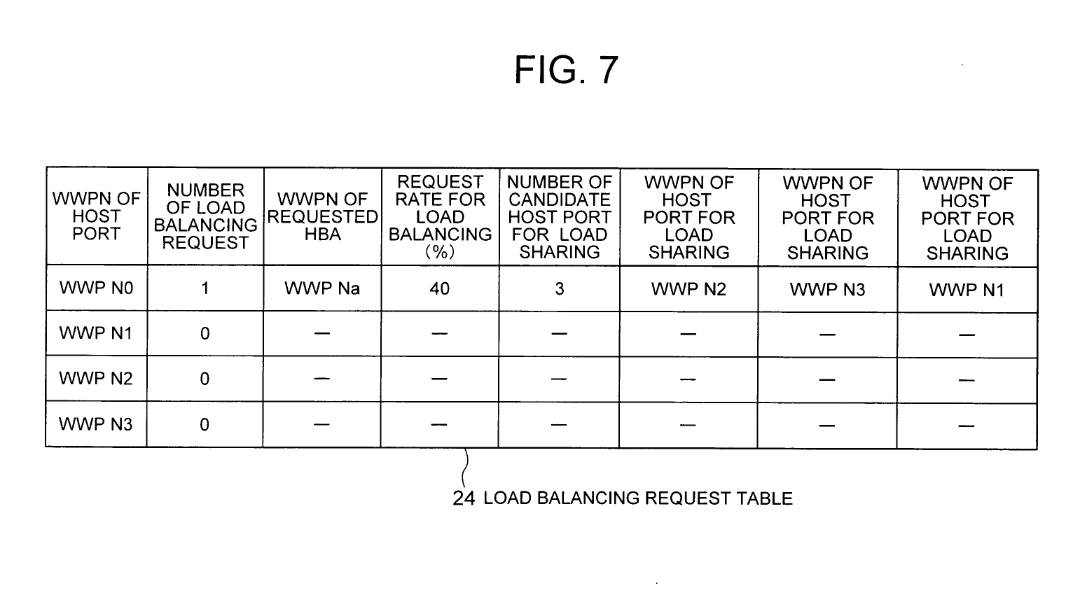

As shown in FIG. 7, a rate (%) of the load balancing request may be provided in the load balancing request table 24. It shows that I/Os to be issued from the load balancing requesting WWPNa to the host port WWPN0 is going to be distributed to one or a plurality of the candidate host ports for load sharing shown with WWPN2, 3, 1 at the rate specified by the rate of load balancing request (%). In a case of FIG. 7, the path redundant driver 4 performs load balancing at S407 in FIG. 5. distributing 40% of I/Os, which is to be sent to the host port 16 usually, to the host port 18

In accordance with the above, load balancing for a host port which is I/O loaded intensively can be controlled precisely.

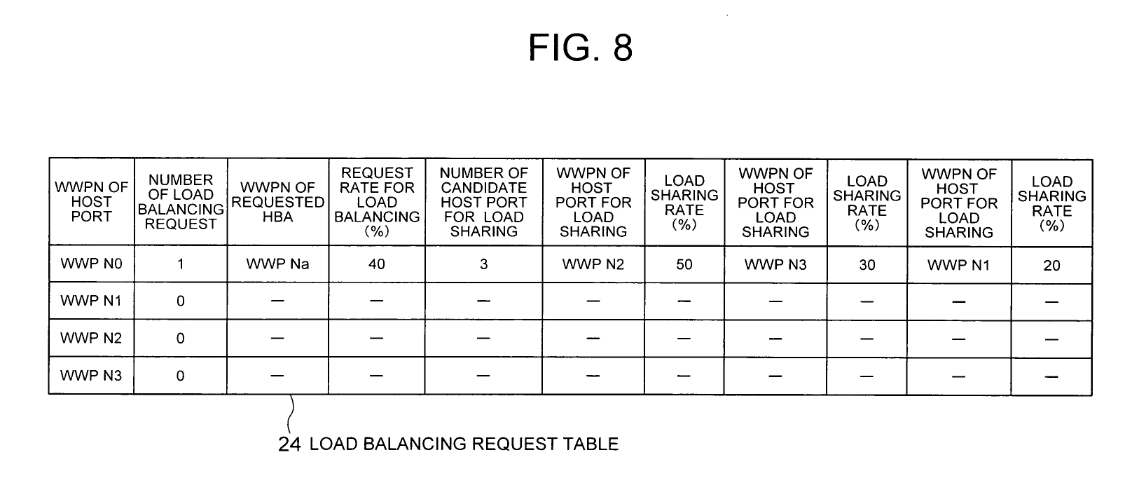

As shown in FIG. 8, the load sharing rate (%) of the host ports 18 (WWPN2), 19 (WWPN3), 17 (WWPN1) may be provided additionally in the load balancing request table 24. Provided the host computer 1a connected to all of the host ports, the path redundant driver 4 performs load balancing in S407 of FIG. 5 distributing 40% of I/Os to be sent to the host port 16 usually, in which 50% of those I/Os to be distributed is shared by the host port 18, 30% is shared by the host port 19, and 20% is shared by the host port 17.

In accordance with the above, load balancing for a host port which is I/O loaded intensively, and besides, sharing rate of a host port which is to be distributed the loads can be controlled precisely.

In FIG. 2, the host computer having two of HBAs 6 and 7 is shown as a configuration example. The number of HBAs is limited by a type of OS operating in the host computer, the driver 5, or hardware of the host computer 1, however, it is not limited by the path redundant driver 4.

In FIG. 2, the disk array sub-system 10 having two of controllers 11 and 12 is shown as a configuration example, however, the number of the controllers is not limited.

In FIG. 2, the disk array sub-system 10 having controllers 11 and 12 with two of host ports respectively is shown as a configuration example, however, the number of host ports at the controller is not limited.

In FIG. 1, the configuration in which HBAs 6, 7 and controllers 11, 12 are connected with each other through the FC switches 40 and 41 is shown as a configuration example, however, these may be connected through a hub, and besides, these may be connected directly through a host interface cable without a switch or a hub.

In FIG. 2, the logical disk 13 and the like in the disk array sub-system 10 are shown as an example, however, these may be configured with an external disk such as JBOD (Just Bunch of Disks) and the like connected to the disk array sub-system 10.

The number of disk array sub-systems 10 connected to the host computer 1 in FIGS. 1 and 2 is not limited.

The number of logical disks configured in the disk array sub-system 10 in FIG. 1 is not limited.

The number of inner buses within the disk array sub-system 10 in FIG. 1 is not limited.

According to the present exemplary embodiment, the disk array sub-system 10 is shown as an example of a storage sub-system, however, another type of devices may be used.

Next, another exemplary embodiment of the present invention will be explained. A controller of a storage sub-system according to the exemplary embodiment of the present invention may be configured with functions of generating and updating periodically a load balancing request table including information which indicates whether each host port needs to be load balanced or not, host bus adapter identifying information which identifies a host bus adapter of the host computer requesting load balancing, and information which identifies a host port to share a load, and sending the load balancing request table to the host computer upon request of the host computer.

According to the above storage sub-system, the controller sends the load balancing request table in response to a request of the host computer. The load balancing request table indicates information such as the one specifying a host port for load sharing, so that the host computer can perform load balancing processing in accordance with the information included in the load balancing request table. That is, the storage sub-system and the host computer cooperate with each other so as to realize an autonomous load balancing function.

In the above storage sub-system, the load balancing request table may include information which specifies a rate of I/O commands to be performed load balancing among I/O commands sent by the host bus adapter requested load balancing.

In accordance with the above, the host computer sends only a part of the I/O commands to be sent to a different host port from a usual one, so that the load balancing processing can be controlled more precisely.

In the above storage sub-system, the load balancing request table may include information which specifies a rate of I/O commands to be sent by the requesting host bus adapter at each host ports to share the loads.

In accordance with the above, the host computer sends I/O commands to a plurality of different host port from a usual one, so that the load balancing processing can be controlled more precisely.

In the above storage sub-system, the controller may delete information about a host bus adapter, which does not respond within a prescribed period after the load balancing request table is sent, of the host bus adapters requesting load balancing.

In accordance with the above, generating process for the load balancing processing request table can be shorten excluding such a host bus adapter of a host computer from an object for the load balancing processing request table in a case with the connected host computer having no load balancing processing function or having only one connection path to a storage sub-system.

The host computer according to the exemplary embodiment of the present invention may be configured with a load balancing performing unit for requesting the storage sub-system to send the load balancing request table including information which indicates whether each host port of the storage sub-system needs to be load-balanced or not, host bus adapter identifying information which identifies a host bus adapter requesting load balancing, and information which identifies a host port to share a load, and performing load balancing in accordance with the information included in the load balancing request table when the host bus adapter identifying information of the load balancing request table sent by the storage sub-system in response to the request includes information corresponding to a host bus adapter thereof.

According to the above host computer, the load balancing request table received from the storage sub-system indicates the information such as the one specifying a host port for load sharing, so that the load balancing processing can be performed in accordance with the information included in the load balancing request table. That is, the storage sub-system and the host computer cooperate with each other so as to realize an autonomous load balancing function.

Further, according to whether the load balancing request table can be obtained or not, it is possible to find out whether an I/O path to the storage sub-system functions normally or not. That is, the load balancing request table obtaining processing can substitute for the path monitoring processing performed conventionally. Accordingly, an extra I/O load is not generated because of the cooperation with the storage sub-system.

The storage system according to the exemplary embodiment of the present invention comprises a host computer and a storage sub-system.

The storage sub-system has a plurality of host ports for receiving an I/O command from the host computer and a controller for performing read-out and write-in to/from a storage device in accordance with the I/O command, wherein the controller has the functions of generating and updating periodically a load balancing request table including information which indicates whether each host port needs to be load-balanced or not, host bus adapter identifying information which identifies a host bus adapter of a host computer requesting load balancing, and information which identifies a host port to share a load, and sending the load balancing request table to the host computer upon request of the host computer.

The host computer has a plurality of host bus adapter for sending an I/O command to a storage sub-system, and a load balancing performing unit for requesting the storage sub-system to send the load balancing request table, and performing load balancing in accordance with the information included in the load balancing request table when the host bus adapter identifying information of the load balancing request table sent from the storage sub-system in response to the request includes information corresponding to a host bus adapter thereof.

According to the above storage system, the controller of the storage sub-system sends the load balancing request table in response to a request of the host computer. The load balancing request table indicates the information such as the one specifying a host port for load sharing, so that the host computer can perform the load balancing processing in accordance the information included in the load balancing request table. That is, the storage sub-system and the host computer cooperate with each other so as to realize an autonomous load balancing function.

The load balancing method according to the exemplary embodiment of the present invention may be structured, wherein the storage sub-system generates and updates periodically a load balancing request table including information which indicates whether each host port needs to be load-balanced or not, host bus adapter identifying information which identifies a host bus adapter of a host computer requesting load balancing, and information which identifies a host port to share a load, the host computer requests the storage sub-system to send the load balancing request table, the storage sub-system sends the load balancing request table to the host computer in response to the request, and the host computer performs load balancing in accordance with the information included in the load balancing request table when the host bus adapter identifying information of the load balancing request table received from the storage sub-system includes information corresponding to a host bus adapter thereof.

According to the above load balancing method, the storage sub-system sends the load balancing request table upon request of the host computer. The load balancing request table indicates the information such as the one specifying a host port for load sharing, so that the host computer can perform the load balancing processing in accordance with the information included in the load balancing request table. That is, the storage sub-system and the host computer cooperate with each other so as to realize an autonomous load balancing function.

Further, according to whether the load balancing request table can be obtained or not, it is possible to find out whether an I/O path between the host computer and the storage sub-system functions normally. That is, the load balancing request table obtaining processing can substitute for the path monitoring processing performed conventionally. Accordingly, an extra I/O load is not generated because the host computer and the storage sub-system cooperate with each other.

In the above load balancing method, the load balancing request table may include information which specifies a rate of I/O commands to be performed load balancing among the I/O commands sent by the requested host bus adapter.

In accordance with the above, the host computer sends only a part of the I/O commands to be sent to a different host port from a usual one, so that the load balancing processing can be controlled more precisely.

In the above load balancing method, the load balancing request table may include information which specifies a rate of I/O commands sent from the requesting host bus adapter at each host port to share the loads.

In accordance with the above, the host computer sends an I/O command to a plurality of host ports different from a usual one, so that the load balancing processing can be controlled more precisely.

In the above load balancing method, the storage sub-system may delete information about a host bus adapter, which dose not respond within a prescribed period after the load balancing request table is sent, of the host bus adapters requested load balancing from the load balancing request table.

In accordance with the above, a generating processing for the load balancing processing request table can be shorten excluding such a host bus adapter of a host computer from an object for the load balancing processing request table in a case with a host computer without a load balancing processing function or with only one connection path to a storage sub-system.

The load balancing program according to the exemplary embodiment of the present invention makes a storage sub-system execute performance of generating and updating periodically a load balancing request table including information which indicates whether each host port needs to be load-balanced or not, host bus adapter identifying information which identifies a host bus adapter of a host computer requesting load balancing, and information which identifies a host port to share a load, and sending the load balancing request table to the host computer upon request of the host computer.

According to the above load balancing program, the storage sub-system is controlled so as to send the load balancing request table in response to a request of the host computer. The load balancing request table indicates the information such as the one specifying a host port for load sharing, so that the host computer can perform the load balancing processing in accordance with the information included in the load balancing request table. That is, the storage sub-system and the host computer cooperate with each other so as to realize an autonomous load balancing function.

Further, according to whether the load balancing request table can be obtained or not, it is possible to find out whether an I/O path between the host computer and the storage sub-system functions normally or not. That is, the load balancing request table obtaining processing can substitute for the path monitoring processing performed conventionally. Accordingly, an extra I/O load is not generated because of the cooperation of the host computer and the storage sub-system.

In the above load balancing program, the load balancing request table may include information which specifies a rate of I/O commands to be performed load balancing among I/O commands sent by the host bus adapter to request.

In accordance with the above, the host computer sends only a part of the I/O commands to be sent to a host port different from a usual one, so that the load balancing processing can be controlled more precisely.

In the above load balancing program, the load balancing request table may include information which specifies a rate of I/O commands sent by the requesting host bus adapter at each load sharing host port.

In accordance with the above, the host computer sends the I/O commands to a plurality of host ports different from a usual one, so that the load balancing processing can be controlled more precisely.

The above load balancing program may make the storage sub-system execute deleting information about a host bus adapter, which dose not respond within a prescribed period after the load balancing request table is sent, of the host bus adapters requesting load balancing from the load balancing request table.

In accordance with the above, the load balancing request table generating processing can be shorten by excluding a host bus adapter of a host computer from the load balancing processing request table in a case with the host computer having no load balancing function or having only one connection path to a storage sub-system.

The second load balancing program according to the exemplary embodiment of the present invention may make the host computer execute processing for requesting a storage sub-system to send a load balancing request table including information which indicates whether each host port of the storage sub-system needs to be load-balanced or not, host bus adapter identifying information which identifies a host bus adapter requesting load balancing, and information which identifies a host port to share a load, and performing load balancing in accordance with the information included in the load balancing request table when the host bus adapter identifying information in the load balancing request table sent by the storage sub-system in response to the request includes information corresponding to a host bus adapter thereof.

According to the above load balancing program, the load balancing request table received from the storage sub-system indicates the information such as the one specifying a host port for load sharing, so that the host computer can perform the load balancing processing in accordance with the information included in the load balancing request table. That is, the storage sub-system and the host computer cooperate with each other so as to realize an autonomous load balancing function.

Further, according to whether the load balancing request table can be obtained or not, it is possible to know whether an I/O path between the host computer and the storage sub-system functions normally or not. That is, the load balancing request table obtaining processing can substitute for the path monitoring processing performed conventionally. Accordingly, an extra I/O load is not generated because of the cooperation with the storage sub-system.

The above load balancing program may be included as a function of the path redundant driver operating in the host computer.

In accordance with the above, the load balancing in cooperation with the storage sub-system is processed covered within the path redundant driver, so that a program which operates in a different layer from the path redundant driver in the host computer, such as, the upper driver, the lower drive, the middleware, the application program, or the like does not need to be remodeled.

According to the present exemplary embodiment, a WWPN is used as identification information of HBAs and host ports. However, the identification information is not limited to WWPNs, and any information can be the identification information as long as HBAs and host ports can be uniquely identified therewith.

Explained various embodiments with reference to the drawings, however, the present invention is not limited to the embodiments. They can be changed variously as long as they adhere to a purpose of claims, and also these various changes are included in the claims.

What is claimed is:

1. A storage system comprising:
a host computer; and
a storage sub-system for performing a storage processing upon receipt of an I/O command from the host computer; wherein,
the storage sub-system includes a function of having a load balancing request table for managing practical information on an operation status of a plurality of host port receiving an I/O command from the host computer so as to output the load balancing request table in response to the request of the host computer; and
the host computer includes a function of receiving the load balancing request table outputted from the storage sub-system so as to perform a balancing processing of the I/O command with respect to the host port based on the received load balancing request table.

2. The storage system, as claimed in claim 1, wherein
the storage sub-system includes:
a plurality of host ports for receiving an I/O command from a host computer; and
a controller for performing read-out/write-in from/to a storage device in accordance with the I/O command, wherein the controller has the functions of: generating and updating periodically a load balancing request table including information which indicates whether each of the host port needs to be load-balanced or not, host bus adapter identifying information which identifies a host bus adapter of the host computer requesting load balancing, and information which identifies a host port to share a load, and sending the load balancing request table to the host computer upon request of the host computer;
the host computer includes:
a plurality of host bus adapters for sending an I/O command to the storage sub-system; and
a load balancing performing unit for requesting the storage sub-system to send the load balancing request table, and performing load balancing in accordance with information included in the load balancing request table when the host bus adapter identifying information in the load balancing request table sent by the storage sub-system in response to the request includes information corresponding to a host bus adapter thereof.

3. The storage system, as claimed in claim 2, wherein the load balancing request table includes information which specifies a rate of I/O commands to be performed load balancing in the I/O commands sent by the requesting host bus adapter.

4. The storage system, as claimed in claim 2, wherein the load balancing request table includes information specifying a rate of I/O commands to be sent by the requesting host bus adapter at each of the load sharing host port.

5. The storage system, as claimed in claim 2, wherein the controller includes a function of deleting information on a host bus adapter, which dose not respond within a prescribed period after the load balancing request table is sent, of the host bus adapters requesting load balancing from the load balancing request table.

6. A storage sub-system used for a storage system in which a host computer sends an I/O command and the storage sub-system received the I/O command performs a storage processing, the storage sub-system comprising:
a load balancing request table managing practical information on an operation status of a plurality of host ports receiving an I/O command from the host computer; and
an output unit which outputs the load balancing request table in response to a request from the host computer.

7. The storage sub-system, as claimed in claim 6, comprising:
a plurality of host ports which receives an I/O command from a host computer; and
a controller for performing read out data from or write in the data to a storage device in accordance with the I/O command, wherein
the controller includes functions of generating and updating periodically a load balancing request table including information which indicates whether each of the host port needs to be load-balanced or not, host bus adapter identifying information which identifies a host bus adapter of the host computer requesting load balancing, and information which identifies the host port to share a load, and sending the load balancing request table to the host computer upon request of the host computer.

8. The storage sub-system, as claimed in claim 7, wherein the load balancing request table includes information which specifies a rate of I/O commands to be performed load balancing in the I/O commands sent by the requesting host bus adapter.

9. The storage sub-system, as claimed in claim 7, wherein the load balancing request table includes information which specifies a rate of I/O commands sent by the requesting host bus adapter at each of the load sharing host port.

10. The storage sub-system, as claimed in claim 7, wherein the controller deletes information on a host bus adapter, which dose not respond within a prescribed period after the load balancing request table is sent, of the host bus adapters requesting load balancing from the load balancing request table.

11. A host computer used for a storage system in which the host computer sends an I/O command and a storage sub-system received the I/O command performs a storage processing, the host computer comprising:
a first unit which requests the storage sub-system to send a load balancing request table which manages practical information on an operation status of a plurality of host ports receiving the I/O command; and
a second unit which performs a balancing processing of the I/O command with respect to the host port based on the received load balancing request table.

12. The host computer, as claimed in claim 11, wherein the load balancing request table includes information which indicates whether each host port of the storage sub-system needs to be load-balanced or not, host bus adapter identifying information which identifies a host bus adapter requesting load balancing, and information which identifies a host port to share a load, with respect to the storage sub-system.

13. A load balancing method for balancing a load of a host port receiving an I/O command from a host computer in a storage sub-system, comprising:
generating, by the storage sub-system, a load balancing request table including information which indicates whether each of the host port needs to be load-balanced or not, host bus adapter identifying information which identifies a host bus adapter of the host computer requesting load balancing, and information which identifies a host port to share a load;
receiving, by the host computer, the load balancing request table from the storage sub-system; and
performing, by the host computer, load balancing in accordance with information included in the load balancing request table when the host bus adapter identifying information of the load balancing request table received from the storage sub-system includes information corresponding to a host bus adapter thereof.

14. A load balancing program making a storage system function for performing a storage processing at a storage sub-system receiving an I/O command sent by a host computer executed, the program making:
a computer of the storage sub-system execute a function of having a load balancing request table which manages practical information on an operation status of a plurality of host ports receiving an I/O from the host computer so as to output the load balancing request table in response to a request of the host computer; and
the host computer execute a function of receiving the load balancing request table outputted from the storage sub-system so as to perform a balancing processing of the I/O command with respect to the host port based on the received load balancing request table.
